(19) United States
(12) Patent Application Publication
(10) Pub. No.: US 2008/0178263 A1
(43) Pub. Date: Jul. 24, 2008

(54) NETWORK OUTPUT SYSTEM AND REGISTRATION METHOD OF AUTHENTICATION INFORMATION

(75) Inventor: Hiroyuki TANAKA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/017,477

(22) Filed: Jan. 22, 2008

(30) Foreign Application Priority Data
Jan. 23, 2007 (JP) P2007-012309

(51) Int. Cl. H04L 9/32

(52) U.S. Cl. 726/2

(57) ABSTRACT

A network output system includes a user device that transmits output data containing authentication information, and an output device that has a reading unit and receives the output data from the user device and that outputs data contained in the output data when the authentication information contained in the output data is identical to the authentication information read from the reading unit. The user device includes a memory that stores the authentication information received from the output device, and a processor that controls to transmit identification information for identifying its own device on a network to the output device, and to store the authentication information in the memory. The output device includes a processor that controls to receive the identification information, to receive authentication information from the reading unit, and to transmit the authentication information read from the reading unit to the user device identified by the identification information.

### BACKGROUND

The present invention relates to a network output system, in which one or more user devices that transmit output data that contains authentication information and data to be output are connected via a network to an output device, connected to a reading device, that outputs the data contained in the output data when the authentication information contained in the output data from the user device is identical to the authentication information read by the reading device. More particularly, the invention relates to registration of authentication information in a user device.

In recent years, a network output system in which output data from a personal computer (hereinafter, referred to as PC) is transmitted via a network to a printer so that the output data is printed by the printer has been widely used. In such a network output system, printers are installed at a remote site from the PC. For this reason, there is a fear that a malicious third party may pry into the printed document before the document is sent to the user who issued an output request to the printer. Therefore, when dealing with a highly confidential document, it is desired to ensure security against prying into the printed document.

To ensure security of such a printed document, various techniques are contemplated. For example, a confidential printing is known in which output data transmitted from a PC is stored in a large-capacity storage device such as a hard disk drive (HDD) that is attached to a printer, and in which user authentication is performed using passwords when users print the output data, thereby preventing a malicious third party from accessing the printed document.

In recent years, with the spread of IC cards or biometric authentication, there is proposed a method of performing user authentication using ID cards instead of passwords (for example, see Patent Document 1), or a method of performing user authentication using biometric data extracted from users (for example, see Patent Document 2).

In the case of confidential printing using IC cards, a method is proposed which enables confidential printing using IC cards by inputting a serial number printed on the surface of an IC card in a PC without needing to equip the PC with an IC card reader or writer (for example, see Patent Document 3).

[Patent Document 1] JP-A-11-150559

[Patent Document 2] JP-A-2001-051915

[Patent Document 3] JP-A-2005-216133

In the conventional techniques described in Patent Documents 1 and 2, biometric data extracted from the users or invisible data stored in an information storage medium such as an IC card is used as authentication information of the user authentication. Thus, it is difficult for a third party to tamper with the authentication information used in the user authentication. However, in the techniques described in Patent Documents 1 and 2, in order to register authentication information in PCs, there is a problem that a reading device such as a biometric sensor or an IC card reader needs to be attached to all the PCs connected to a network and that a dedicated software for operating such a reading device needs to be installed in the PCs. For this reason, as the number of PCs connected to the network increases, the cost of the network output system is also increased.

In the conventional technique described in Patent Document 3, by using the serial number printed on the surface of the IC card, it is possible to improve the usability in printing operations compared with user authentication by password input. However, it is difficult to ensure such confidentiality that allows using the biometric data or data stored in IC cards.

In the case in which a user device and an output device are connected to a wide area network such as the Internet and a user who issues an output request using the user device is different from a user who performs an output operation using the output device, or in the case of using a facsimile communication, it is necessary to perform the extraction of the biometric data of the user who performs the output operations using the output device or the registration of authentication data of the IC card on the user device side. Therefore, it becomes difficult to introduce the network output system.

### SUMMARY

The present invention is made in view of the above-described problems, and an object of the invention is to provide a network output system capable of registering authentication information to ensure confidentiality without needing to connect a reading device to user device.

In order to achieve the above object, according to the present invention, there is provided a network output system, including:

a user device that transmits output data containing authentication information; and

an output device that has a reading unit and receives the output data from the user device and that outputs data contained in the output data when the authentication information contained in the output data is identical to the authentication information read from the reading unit,

wherein the user device includes:
a memory that stores the authentication information received from the output device; and
a processor that controls to transmit identification information for identifying its own device on a network, to the output device, and to store the authentication information received from the output device in the memory, and

wherein the output device includes a processor that controls to receive the identification information from the user device, to receive authentication information from the reading unit, and to transmit the authentication information read from the reading unit to the user device identified by the identification information.

According to the invention, a user device transmits identification information for identifying its own device to the output device. The output device manages the identification information received from the user device and authentication information read by a reading unit. Upon receiving the identification information from the user device, the output device notifies the user device of the authentication information managed therein so that the user device registers the authentication information. Therefore, it is possible to provide a network output system capable of registering the authentication information to ensure confidentiality without needing to connect the reading device to the user device.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a block diagram showing a construction of a network output system according to a first embodiment of the invention;

FIG. 2 is a block diagram showing a construction of a printer shown in FIG. 1;

FIG. 3 is a diagram showing a configuration of a management table shown in FIG. 2;

FIG. 4 is a block diagram showing a construction of a PC shown in FIG. 1;

FIG. 5 is a block diagram showing constructions of the printer shown in FIG. 2 and the PC shown in FIG. 4, related to an identification information registration process and an authentication information registration process;

FIG. 6 is a flow chart for explaining operations of the PC for the identification information registration process according to the first embodiment;

FIG. 7 is a diagram for explaining an authentication registration screen;

FIG. 8 is a flow chart for explaining operations of the printer for the identification information registration process according to the first embodiment;

FIG. 9 is a flow chart for explaining operations for a first authentication information registration process of registering authentication information in the printer according to the first embodiment;

FIG. 10 is a flow chart for explaining operations of the PC for a second authentication information registration process of registering authentication information in the PC according to the first embodiment;

FIG. 11 is a flow chart for explaining operations of the printer for the second authentication information registration process of registering authentication information in the PC according to the first embodiment;

FIG. 12 is a block diagram showing constructions of the printer and the PC, related to an identification information registration process and an authentication information registration process according to a second embodiment;

FIG. 13 is a block diagram showing constructions of the printer and the PC, related to an identification information registration process and an authentication information registration process according to a third embodiment;

FIG. 14 is a block diagram showing constructions of the printer and the PC, related to an authentication information registration process according to a fourth embodiment;

FIG. 15 is a flow chart for explaining operations of a network output system for an authentication information registration process according to the fourth embodiment; and

FIG. 16 is a diagram showing an example of a registration method selection screen.

### DETAILED DESCRIPTION

Hereinafter, embodiments of the invention will be described. However, the invention is not limited to the embodiments, and appropriate modifications and changes can be made without departing from the essence of the invention. Further, materials, shapes, dimensions, and forms of the constituent elements can be set arbitrarily and no limitation is placed thereon. Further, each of the embodiments can be mutually utilized within the relevant scope.

### Embodiment 1

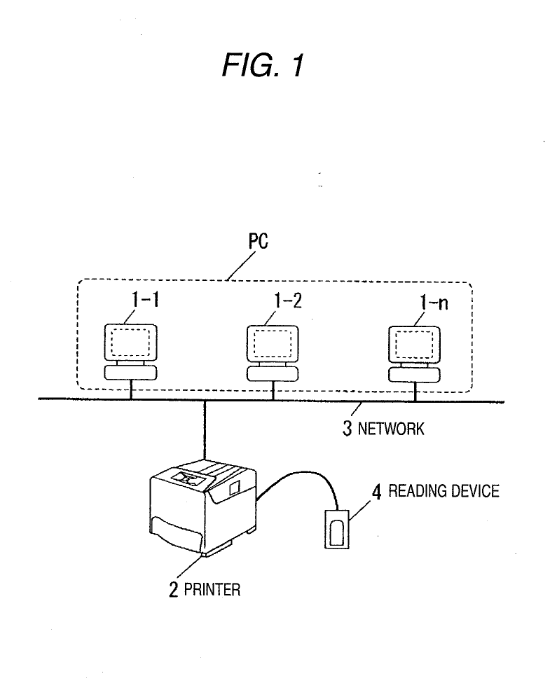

A first embodiment will be described with reference to FIGS. 1 to 11. FIG. 1 is a block diagram showing the construction of a network output system according to the first embodiment. In FIG. 1, reference numeral 1 (1-1 to 1-n) represents a personal computer (hereinafter, referred to as PC), 2 represents a printer, 3 represents a network, and 4 represents a reading device.

In the network output system shown in FIG. 1, n (n: a natural number) PCs 1 are connected to the printer 2 via the network 3 so that plural users of the PC 1 share the printer 2. The printer 2 is connected to the reading device 4 that reads authentication information used for user authentication.

The reading device 4 reads the authentication information for user authentication and transmits the read authentication information to the printer 2. As the authentication information, biometric data or data stored in a portable information storage medium is used, for example. When using biometric data as the authentication information, any method can be used if the method identifies and verifies users with their fingerprints, face, iris, palm pattern and voice pattern. As the biometric data, there are used data acquired by pre-detecting physiological characteristics of users using a biometric sensor. Particularly, in this embodiment, the biometric data are not raw information acquired by the biometric sensor but characteristic information extracted by a predetermined analysis algorithm, for example, positional information of the feature points acquired by the analysis of image data. Doing this is preferable in view of management of personal information and saving of storage capacity.

When using a portable information storage medium as the authentication information, IC cards or SD cards that users can carry along may be used, and any other medium can be used if the medium can store unique user information.

Upon receiving an identification information notice from the PC 1, the printer 2 requests authentication information to the reading device 4 and manages the identification information and the authentication information in a corresponding manner. Upon receiving an authentication information request from the PC 1, the printer 2 notifies the PC 1 of the authentication information corresponding to the PC 1. Upon receiving output data that contains the authentication information and printing data from the PC 1, the printer 2 compares the authentication information contained in the output data with user authentication information obtained from the reading device 4. If the authentication information contained in the output data is identical to the user authentication information obtained from the reading device 4, the printer 2 prints (outputs) the printing data contained in the output data.

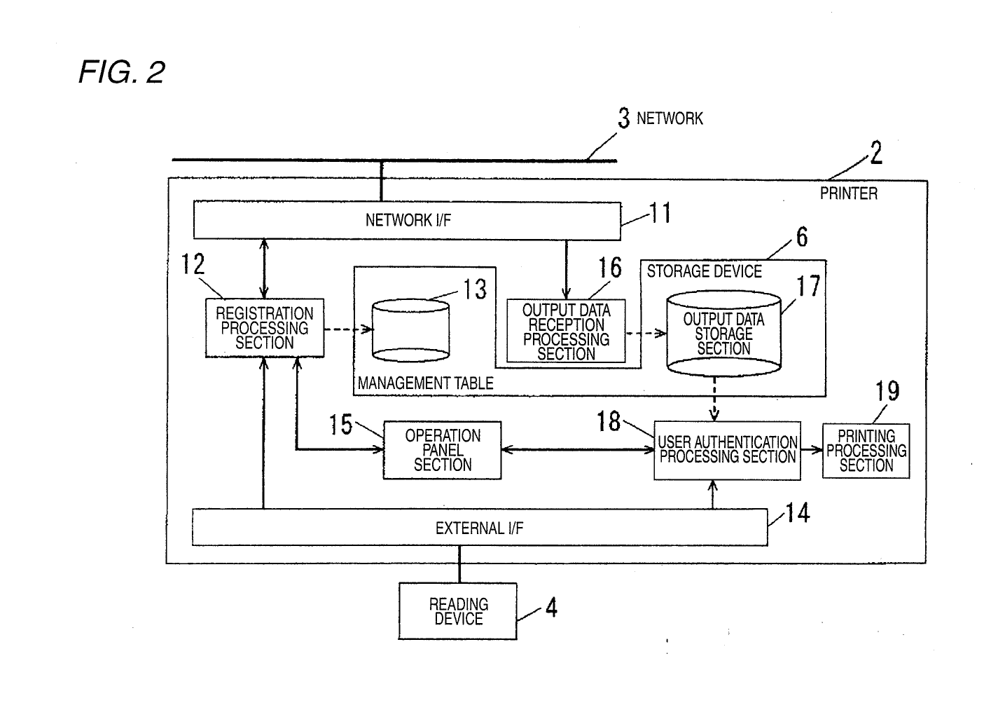

FIG. 2 is a block diagram showing the construction of the printer 2 shown in FIG. 1. In FIG. 2, reference numeral 6 represents a storage device, 11 represents a network interface (hereinafter, referred to as network I/F), 12 represents an registration processing section, 13 represents a management table, 14 represents an external interface (hereinafter, referred to as external I/F), 15 represents an operation panel section, 16 represents an output data reception processing section, 17 represents an output data storage section, 18 represents a user authentication processing section, and 19 represents an output processing section.

The network I/F 11 has an interface function for communicating with the PC 1 via the network 3. When receiving an identification information notice and an authentication information request from the PC 1, the network I/F 11 notifies the registration processing section 12 of the received identification information notice and the authentication information request. When receiving output data from the PC 1, the network I/F 11 outputs the received output data to the output data reception processing section 16. When an authentication information response is input from the registration processing section 12, the network I/F 11 transmits the authentication information response input thereto to the PC 1.

The storage device 6 includes the output data storage section 17 and the management table 13. The output data storage section 17 temporarily retains the output data received from the PC 1.

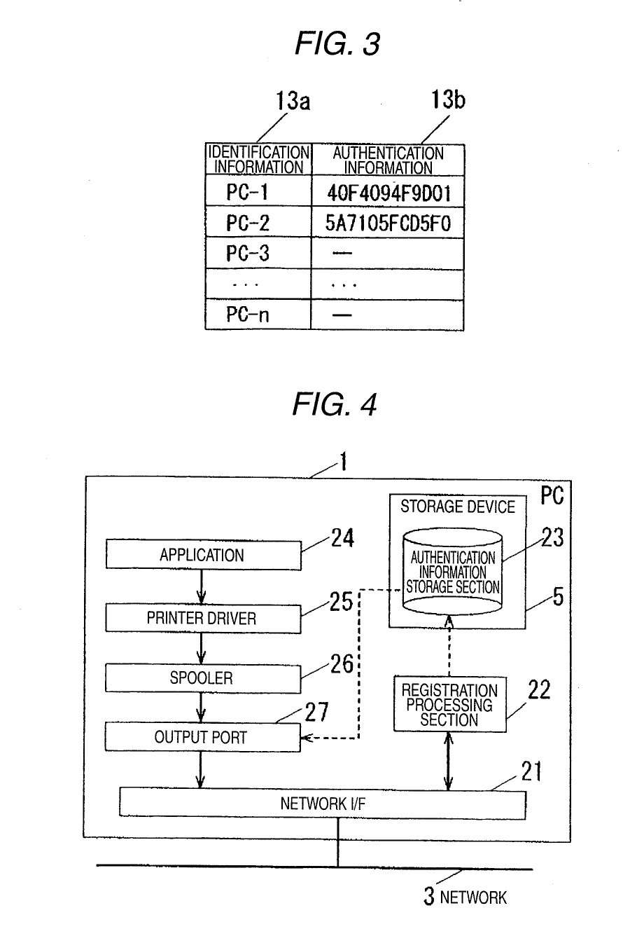

FIG. 3 is a diagram showing the construction of the management table 13 shown in FIG. 2. The management table 13 shown in FIG. 3 includes, as registration items, an identification information data 13a and an authentication information data 13b. In the identification information data 13a, identification information of the respective PCs 1 for identifying the PC 1 on the network 3 are registered. In the authentication information data 13b, authentication information read by the reading device 4 are registered. Incidentally, a plurality of authentication information may be registered to correspond to single identification information.

Referring to FIG. 2, the output data reception processing section 16 stores the output data input from the network I/F 11 in the output data storage section 17. The external I/F 14 has an interface function for communicating with the reading device 4 and outputs the authentication information input from the reading device 4 to the registration processing section 12 and the user authentication processing section 18. Here, as an interface between the external I/F 14 and the reading device 4, for example, USB (Universal Serial Bus) may be used. The printer 2 may have the reading device 4 incorporated therein.

The operation panel section 15 has an interface function for communicating with users. Upon receiving instructions from users through output operations, the operation panel section 15 notifies the user authentication processing section 18 of the instructions.

The registration processing section 12 performs an authentication information registration process. The registration processing section 12 registers the identification information of the respective PCs 1, pre-assigned to identify the PCs 1 on the network 3 and the authentication information received from the reading device 4 via the external I/F 14 in the management table 13 in a corresponding manner. Upon receiving the authentication information request from the network I/F 11, the registration processing section 12 outputs the authentication information response that contains the authentication information registered in the management table 13, corresponding to the PC 1, which is a transmission source of the authentication information request, to the network I/F 11.

The output data reception processing section 16 stores the output data input from the network I/F 11 in the output data storage section 17. Upon receiving the instructions from the operation panel section 15, the user authentication processing section 18 acquires the user authentication information from the reading device 4 via the external I/F 14 and compares and verifies the acquired authentication information with the authentication information contained in the output data stored in the output data storage section 17.

When the results of comparison and verification in the user authentication processing section 18 show that the acquired authentication information is identical to the authentication information contained in the output data stored in the output data storage section 17, the output processing section 19 analyzes the printing data contained in the output data and performs necessary output processing.

The PC 1 transmits an identification information notice that contains identification information for identifying itself and transmits an authentication information request to the printer 2 to acquire its own authentication information. When printing output data, the PC 1 transmits the authentication information acquired by performing the authentication information request and the output data that contains the printing data to be printed (output), to the printer 2.

FIG. 4 is a block diagram showing the construction of the PC 1 shown in FIG. 1. In FIG. 4, reference numeral 21 represents a network I/F, 22 represents an registration processing section, 23 represents an authentication information storage section, 24 represents an application, 25 represents a printer driver, 26 represents a spooler, and 27 represents an output port.

The network I/F 21 has an interface function for communicating with the printer 2 via the network 3. The network I/F 21 transmits an identification information notice, an authentication information request, and output data to the printer 2 and receives an identification information response from the printer 2. The authentication information storage section 23 stores the authentication information acquired by performing the authentication information request.

The registration processing section 22 performs an authentication information registration process. The registration processing section 22 transmits an identification information notice that contains identification information for identifying itself to the printer 2 via the network I/F 21. Moreover, the registration processing section 22 transmits an authentication information request for its own authentication information to the printer 2 via the network I/F 21 to acquire the authentication information and stores the acquired authentication information in the authentication information storage section 23.

The application 24 generates document data that contains image data. The printer driver 25 converts the document data generated by the application 24 to printing data such as PDL (Page Description Language) that can be recognized by the printer 2. The spooler 26 temporarily retains the printing data generated by the printer driver 25. The output port 27 transmits output data that contains the printing data temporarily retained in the spooler 26 and the authentication information stored in the authentication information storage section 23, to the printer 2 via the network I/F 21.

Next, an outline of the operations of the network output system will be described with reference to FIGS. 1 to 4. The network output system performs three processes: an identification information registration process, an authentication information registration process, and a printing process. First, an outline of the identification information registration process will be described.

The registration processing section 22 of the PC 1 transmits an identification information notice that contains identification information for identifying itself, to the printer 2 via the network I/F 21. Upon receiving the identification information notice, the network I/F 21 of the printer 2 outputs the received identification information notice to the registration processing section 12. Then, the registration processing section 12 registers the identification information contained in the identification information notice in the identification information data 13a of the management table 13 of the storage device 6.

Next, an outline of the authentication information registration process will be described. When receiving an authentication information registration request from users, the operation panel section 15 sends a notice that a registration of an authentication information is requested to the registration processing section 12. Then, the registration processing section 12 reads and displays the entire identification information registered in the identification information data 13a of the management table 13 on the operation panel section 15. Then, users select one of the identification information displayed on the operation panel section 15. The operation panel section 15 notifies the registration processing section 12 of the identification information selected by the users.

Upon being notified of the identification information by the operation panel section 15, the registration processing section 12 enters an authentication information waiting state. Then, users cause the reading device 4 to read authentication information. The reading device 4 transmits the read authentication information to the printer 2. Upon receiving the authentication information from the reading device 4 via the external I/F 14, the registration processing section 12 of the printer 2 registers the authentication information received from the reading device 4 in the authentication information data 13b of the management table 13, corresponding to the identification information notified from the operation panel section 15. If the authentication information corresponding to the identification information notified from the operation panel section 15 is already registered in the authentication information data 13b of the management table 13, the registration processing section 12 additionally registers the reception information from the reading device 4. With this, the authentication information registration process of the printer 2 is completed.

Upon completion of the authentication information registration process of the printer 2, and in accordance with the instructions from users, the registration processing section 22 of the PC 1 outputs an authentication information request that contains identification information for identifying itself to the printer 2 via the network I/F 21.

Upon receiving the authentication information request via the network I/F 11, the registration processing section 12 of the printer 2 extracts identification information contained in the authentication information request. Then, the registration processing section 12 extracts the authentication information registered in the authentication information data 13b of the management table 13, corresponding to the extracted identification information. If a plurality of authentication information are registered corresponding to the extracted identification information, all of the authentication information is extracted. The registration processing section 12 transmits an authentication information response that contains all of the extracted authentication information to the PC 1, which is a transmission source of the authentication information request, via the network I/F 11.

Upon receiving the authentication information response via the network I/F 21, the registration processing section 22 of the PC 1 stores the authentication information contained in the authentication information response in the authentication information storage section 23. With this, the authentication information registration process of the PC 1 is completed.

Next, the operations of the printing process will be described. The application 24 of the PC 1 generates document data that contains image data and outputs the generated document data to the printer driver 25. The printer driver 25 converts the document data to printing data that can be recognized by the printer 2 and temporarily retains the converted printing data in the spooler 26. The output port 27 reads the authentication information stored in the authentication information storage section 23 and the printing data temporarily retained in the spooler 26. Then, the output port 27 generates output data that contains the read authentication information and printing data and transmits the generated output data to the printer 2 via the network I/F 21.

The output data reception processing section 16 of the printer 2 stores the output data received via the network I/F 11 in the output data storage section 17. Upon receiving output operations from users, the operation panel section 15 outputs output instructions to the user authentication processing section 18. Upon receiving the output instructions, the user authentication processing section 18 enters a user authentication information waiting state to receive user authentication information from the reading device 4. Upon receiving the authentication information from the reading device 4 via the external I/F 14, the user authentication processing section 18 extracts authentication information from the output data stored in the output data storage section 17 and compare and verifies the extracted authentication information with the authentication information obtained from the reading device 4. If the authentication information contained in the output data is identical to the user authentication information obtained from the reading device 4, the user authentication processing section 18 outputs the printing data contained in the output data to the output processing section 19. The output processing section 19 analyzes the printing data input from the user authentication processing section 18 and prints the printing data by performing necessary output processing.

When a plurality of authentication information are registered in the authentication information storage section 23 of the PC 1, the PC 1 transmits output data along with the all authentication information to the printer 2. Then, the printer 2 prints the printing data if the respective authentication information contained in the output data are identical to the authentication information from the reading device 4 or if at least one of the plural authentication information contained in the output data is identical to the authentication information from the reading device 4. The printer 2 may have a selection mode for selecting whether the printing is to be performed when all or at least one of the authentication information are identical.

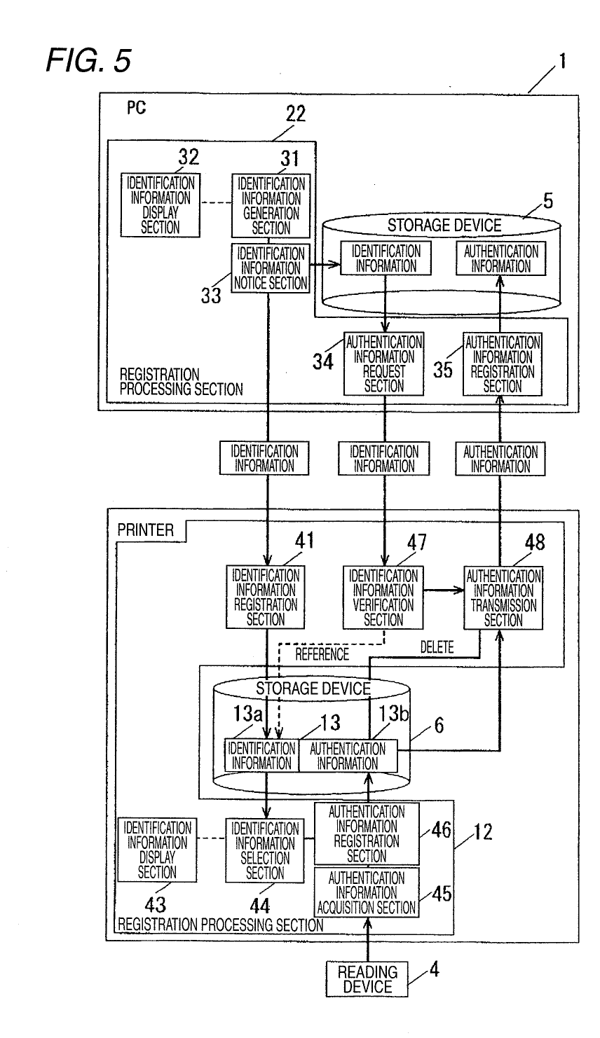

Next, the identification information registration process and the authentication information registration process of the network output system according to the first embodiment will be described in detail. FIG. 5 is a block diagram showing the constructions of the printer 2 shown in FIG. 2 and the PC 1 shown in FIG. 4, for the identification information registration process and the authentication information registration process. The identification information registration process and the authentication information registration process are carried out by the storage device 6 having the management table 13 and the registration processing section 12 of the printer 2 shown in FIG. 2, the storage device 5 having the registration processing section 22 and the authentication information storage section 23 of the PC 1 shown in FIG. 4, and the reading device 4.

As shown in FIG. 5, the registration processing section 22 of the PC 1 includes an identification information generation section 31, an identification information display section 32, an identification information notice section 33, an authentication information request section 34, and an authentication information registration section 35. The registration processing section 12 of the printer 2 includes an identification information registration section 41, an identification information display section 43, an identification information selection section 44, an authentication information acquisition section 45, an authentication information registration section 46, an authentication information verification section 47, and an authentication information transmission section 48.

The authentication information generation section 31 generates identification information for identifying the PC 1. Specifically, as the identification information, there is used information that can identify the PC 1 in the network output system, such as an IP address, a host name, or an MAC address, which are used for identification of devices during communication using the network 3, account information used when users log into the network output system, device unique information maintained in the PC 1, or information generated on a random basis. It is preferable to use information such as a host name or account information that uses can directly memorizes.

The identification information display section 32 has an interface function for communicating with users. The identification information display section 32 displays such as the identification information generated by the identification information generation section 31 and the registration results of the identification information or the authentication information and receives instructions from users by displaying a menu screen for requesting operations. The identification information notice section 33 stores the identification information generated by the identification information generation section 31 in the storage device 5 and generates and transmits an identification information notice that contains the identification information to the printer 2.

The authentication information request section 34 reads the identification information stored in the storage device 5 and transmits an identification information notice that contains the read identification information to the printer 2. The authentication information registration section 35 extracts authentication information contained in the authentication information response received from the printer 2 and stores the extracted authentication information in the authentication information storage section 23 within the storage device 5.

The authentication information registration section 41 extracts authentication information from the authentication information notice from the PC 1 and registers the extracted identification information in the identification information data 13a of the management table 13 within the storage device 6. The identification information display section 43 displays the identification information registered in the identification information data 13a of the management table 13 within the storage device 6. The identification information selection section 44 reads identification information registered in the identification information data 13a of the management table 13 within the storage device 6 in accordance with the instructions from the operation panel section 15 and displays the read identification information on the identification information display section 43. Moreover, the identification information selection section 44 selects the identification information instructed from the operation panel section 15 and notifies the authentication information registration section 46 of the selected identification information.

The authentication information acquisition section 45 acquires authentication information from the reading device 4. The authentication information registration section 46 registers the authentication information acquired by the authentication information acquisition section 45 and the identification information notified from the authentication information selection section 44 in the authentication information data 13b of the management table 13 in a corresponding manner. The identification information verification section 47 extracts the identification information contained in the authentication information request from the PC 1, determines whether the extracted identification information is registered in the identification information data 13a of the management table 13 within the storage device 6, and notifies the authentication information transmission section 48 of the determination results.

If the determination results notified from the identification information verification section 47 show that the identification information is registered, the authentication information transmission section 48 transmits an authentication information response that contains the authentication information registered in the authentication information data 13b of the management table 13 within the storage device 6, corresponding to the identification information, to the PC 1. If the determination results notified from the identification information verification section 47 show that the identification information is not registered, the authentication information transmission section 48 transmits an authentication information response, stating that the identification information is not registered, to the PC 1. After transmitting the authentication information response that contains the authentication information, the authentication information transmission section 48 removes the authentication information contained in the authentication information response and the identification information corresponding to the authentication information from the identification information data 13a and the authentication information data 13b of the management table 13 within the storage device 6.

When a predetermined period has elapsed after the identification information registration section 41 registered the identification information in the identification information data 13a of the management table 13 within the storage device 6, the authentication information transmission section 48 removes the identification information from the management table 13. The measurement of the predetermined period is carried out every identification information using a timer function (not shown) equipped with the printer 2.

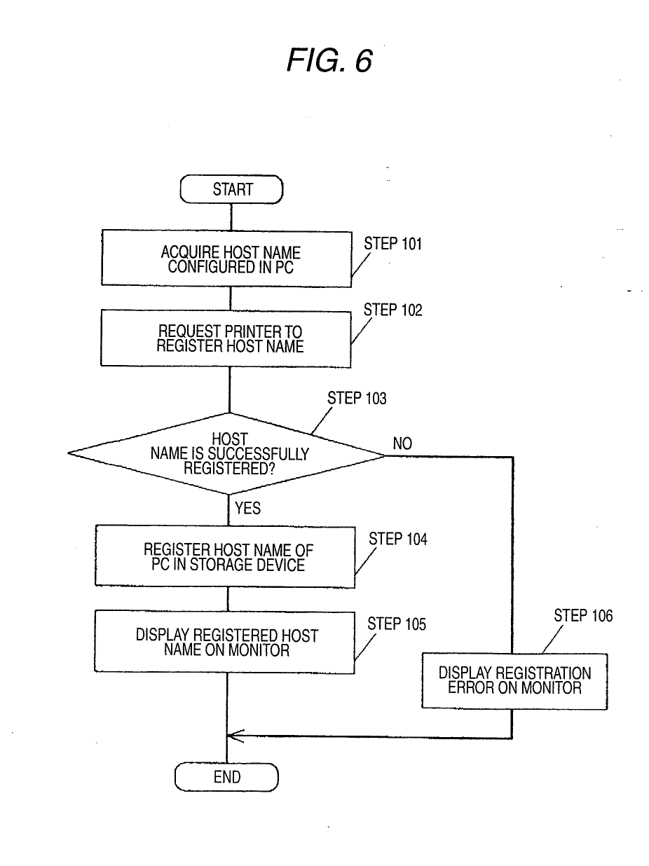

Next, the operations of the identification information registration process and the authentication information registration process of the network output system according to the first embodiment will be described in detail with reference to the flow charts of FIG. 6 and FIGS. 8 to 11. In the following descriptions, a host name, which is also used in TCP/IP communication, is used as the identification information.

First, the operations of the identification information registration process of the PC 1 will be described with reference to the flow chart of FIG. 6. When the installation of the output port 27 into the PC 1 is executed by users, the identification information generation section 31 acquires a host name configured in its own device for use in TCP/IP communication (Step 101). The identification information generation section 31 displays the acquired host name on the identification information display section 32 and notifies the identification information notice section 33 of the acquired host name.

The identification information notice section 33 generates and transmits an identification information notice that contains the host name notified from the identification information generation section 31 to the printer 2 and requests the printer 2 to register the host name (Step 102). Thereafter, the identification information notice section 33 enters a response waiting state to receive a response from the printer 2.

Upon receiving a response from the printer 2, the identification information notice section 33 determines whether the response is a notice that the host name was successfully registered (Step 103). If the response states that the host name was successfully registered, the identification information notice section 33 registers the host name notified from the identification information generation section 31 as identification information in the storage device 5 (Step 104). Moreover, the identification information notice section 33 sends a notice to the identification information generation section 31, stating that the registration was successful.

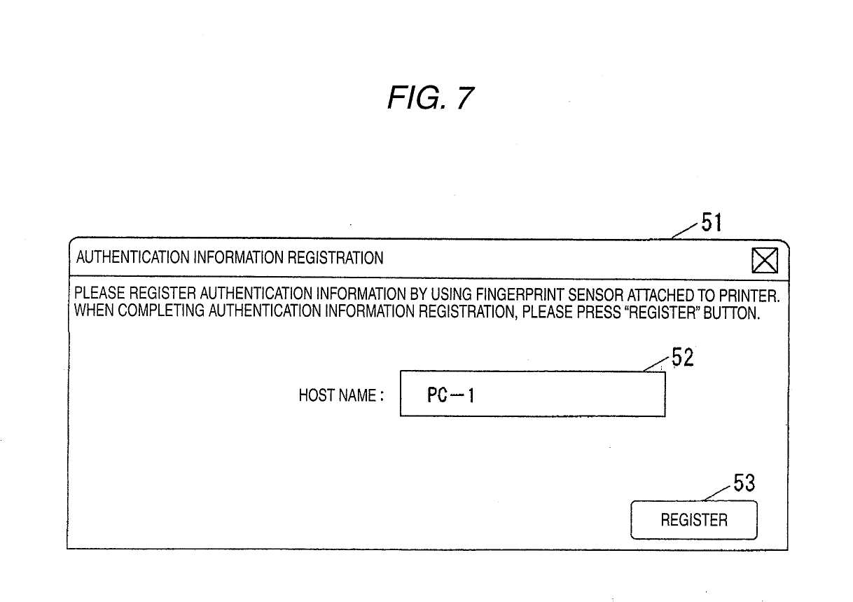

Upon receiving the notice that the registration is successful, the identification information generation section 31 displays an authentication information registration screen (see FIG. 7) that contains the generated host name (registered host name) on the identification information display section 32 (Step 105), thereby finishing the identification information registration process.

On the other hand, when the response from the printer 2 states that the host name is not successfully registered, the identification information notice section 33 sends a notice to the identification information generation section 31, stating that the host name was not successfully registered. Upon receiving the notice, the identification information generation section 31 displays an error message that the registration of the host name was not successful on the identification information display section 32 (Step 106), thereby finishing the identification information registration process.

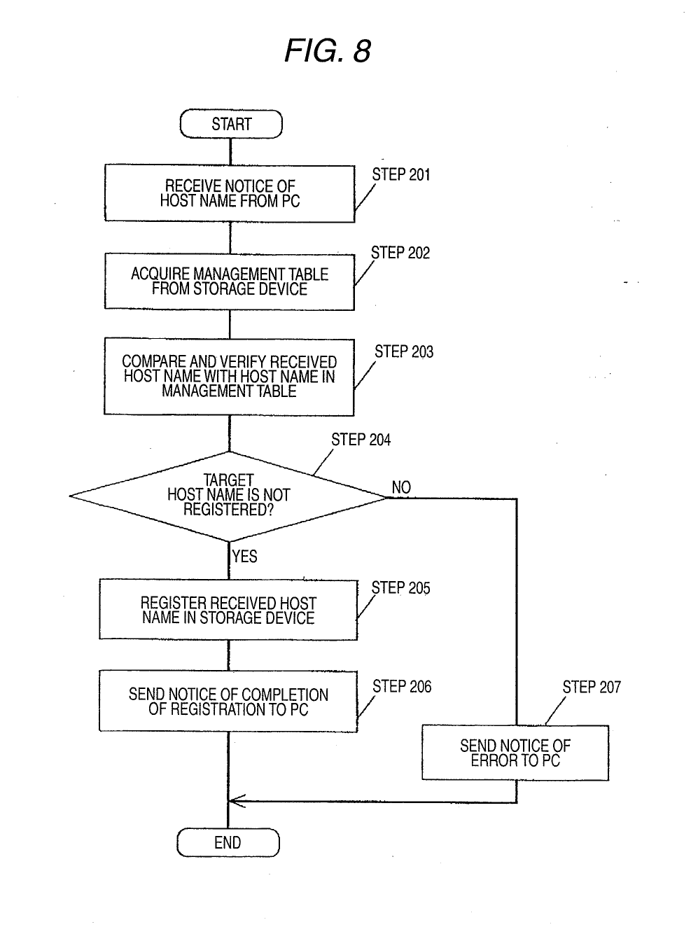

Next, the operations of the identification information registration process of the printer 2 will be described with reference to the flow chart of FIG. 8. Upon receiving an identification information notice that contains a host name from the PC 1 (Step 201), the identification information registration section 41 acquires all the identification information (host names) registered in the identification information data 13a of the management table 13 within the storage device 6 (Step 202). The identification information registration section 41 compares and verifies all of the acquired host names with the host name (target host name) contained in the received identification information notice (Step 203). When the results of comparison and verification show that the target host name is not present in the acquired host names; that is, when the host name contained in the identification information notice is not registered in the management table 13 (Step 204: Yes), the identification information registration section 41 additionally registers the received host name in the identification information data 13a of the management table 13 within the storage device 6 (Step 205). The identification information registration section 41 transmits a response notice of completion of registration, stating that the host name is successfully registered, to the PC 1, which is a transmission source of the identification information notice (Step 206), thereby finishing the identification information registration process.

On the other hand, when the results of comparison and verification show that the target host name is present in the acquired host names; that is, when the host name contained in the identification information notice is already registered in the management table 13 (Step 204: No), the identification information registration section 41 transmits a response notice of error in registration, stating that the host name contained in the identification information notice is already registered in the management table 13 (i.e., stating that the registration is not successful), to the PC 1, which is a transmission source of the identification information notice (Step 207), thereby finishing the identification information registration process.

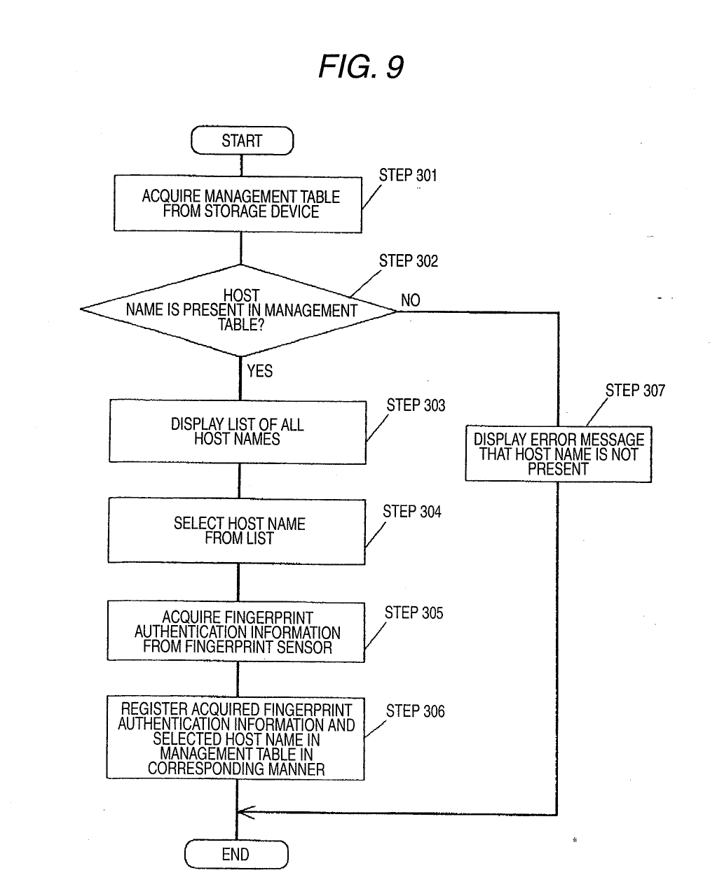

Next, the operations of the authentication information registration process will be described with reference to the flow charts of FIGS. 9 to 11. The authentication information registration process includes a first authentication information registration process for registering authentication information in the printer 2 and a second authentication information registration process for registering authentication information in the PC 1. In the following descriptions, fingerprint authentication information is used as the authentication information, and a fingerprint sensor is used as the reading device 4.

First, the operation of the first authentication information registration process for registering authentication information in the printer 2 will be described with reference to the flow chart of FIG. 9. When detecting an input from users to start registration of authentication information, the operation panel section 15 sends a notice that the registration of authentication information is to be started to the identification information selection section 44. The identification information selection section 44 acquires all the host names registered in the identification information data 13a of the management table 13 within the storage device 6 (Step 301).

When it is possible to acquire the host name, that is, when the host name is present (registered) in the identification information data 13a of the management table 13 (Step 302: Yes), the identification information selection section 44 notifies the identification information display section 43 of all of the acquired host names. The identification information display section 43 displays a list of all of the notified host names (Step 303).

When users select a host name of their PC 1 from the host names displayed on the identification information display section 43 using the operation panel section 15, the operation panel section 15 notifies the identification information selection section 44 of the host name selected by the users (Step 304). The identification information selection section 44 notifies the authentication information registration section 46 of the host name notified from the operation panel section 15. The authentication information registration section 46 sends a notice that fingerprint authentication information is to be acquired to the authentication information acquisition section 45. Then, the authentication information acquisition section 45 acquires fingerprint authentication information from a fingerprint sensor as the reading device 4 (Step 305).

Specifically, the authentication information acquisition section 45 request fingerprint authentication information to the fingerprint sensor as the reading device 4. The fingerprint sensor senses fingers of a user placed thereon to acquire image data of the fingerprint. Then, the fingerprint sensor extracts feature points from the acquired image data of the fingerprint and transmits information on the extracted feature points as the fingerprint authentication information to the printer 2.

Upon receiving the fingerprint authentication information from the fingerprint sensor, the authentication information acquisition section 45 outputs the received fingerprint authentication information to the authentication information registration section 46. The authentication information registration section 46 registers the fingerprint authentication information input from the authentication information acquisition section 45 and the host name notified from the identification information selection section 44 in the authentication information data 13b of the management table 13 within the storage device 6 in a corresponding manner (Step 306).

On the other hand, when it is not possible to acquire the host name from the identification information data 13a of the management table 13 within the storage device 6, that is, when the host name is not present (registered) in the identification information data 13a of the management table 13 (Step 302: No), the identification information selection section 44 sends a notice that the host name is not registered to the identification information display section 43. The identification information display section 43 displays an error message that the host name is not registered (Step 307).

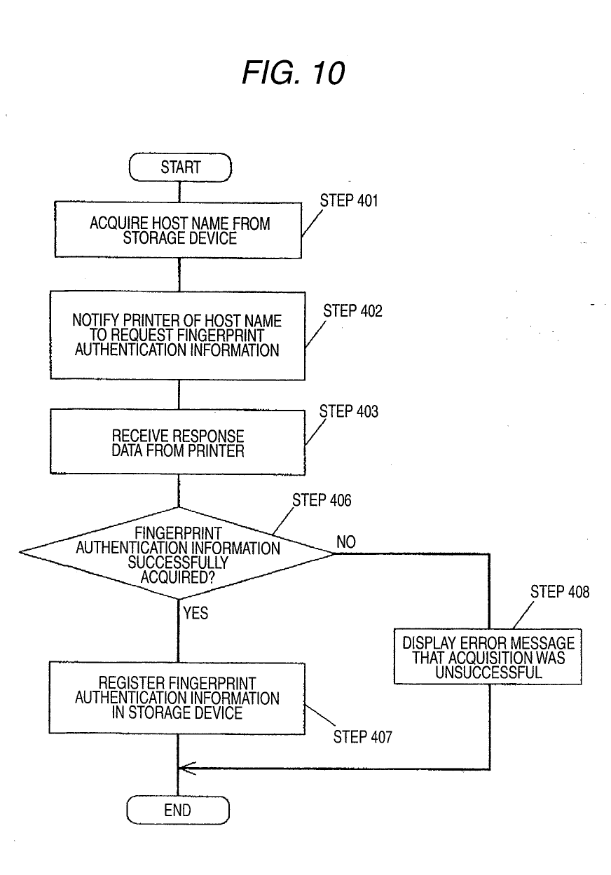

Next, the operation of the second authentication information registration process of the PC 1 for registering authentication information in the PC 1 will be described with reference to the flow chart of FIG. 10. When the identification information registration process of the PC 1 described with reference to the flow chart of FIG. 6 is successful in registering the identification information, the authentication information registration screen 51 shown in FIG. 7 is displayed on the identification information display section 32 of the PC 1. The authentication information registration screen 51 includes a host name display area 52 on which the host name as the identification information is displayed and a Register button 53. Users press the Register button 53 to start the authentication information registration process. Upon detecting the pressing of the Register button 53, the identification information display section 32 sends a notice that the authentication information registration process is to be started to the authentication information request section 34.

The authentication information request section 34 acquires the identification information (host name) stored in the storage device 5 (Step 401). The authentication information request section 34 generates an authentication information request that contains the acquired host name, and transmits the generated authentication information request to the printer 2, thereby requesting the fingerprint authentication information by notifying the printer 2 of the host name (Step 402). With this, the PC 1 enters an authentication information response waiting state.

Upon receiving an authentication information response from the printer 2 (Step 403), the authentication information registration section 35 determines whether the fingerprint authentication information is successfully acquired (Step 406). When the fingerprint authentication information is successfully acquired, that is, when the fingerprint authentication information is contained in the authentication information response (Step 406: Yes), the authentication information registration section 35 extracts the fingerprint authentication information contained in the authentication information response and registers the extracted authentication information in the authentication information storage section 23 within the storage device 5 (Step 407), thereby finishing the authentication information registration process.

On the other hand, when the fingerprint authentication information is not successfully acquired, that is, when an error message is contained in the authentication information response (Step 406: No), the authentication information registration section 35 displays an error message stating that the acquisition of the fingerprint authentication information is not successful on the identification information display section 32 (Step 408), thereby finishing the authentication information registration process.

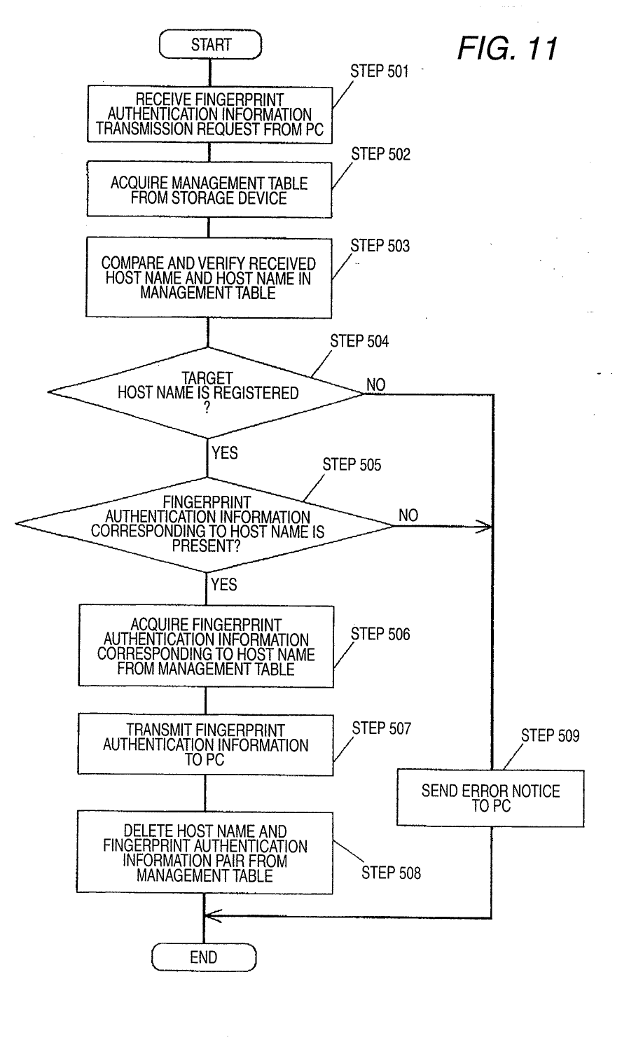

Next, the operation of the second authentication information registration process of the printer 2 for registering authentication information in the PC 1 will be described with reference to the flow chart of FIG. 11. Upon receiving the authentication information request (a fingerprint authentication information transmission request) from the PC 1 (Step 501), the authentication information verification section 47 acquires the host name registered in the identification information data 13a of the management table 13 within the storage device 6 (Step 502). Then, the identification information verification section 47 compares and verifies the host name contained in the authentication information request with the host name acquired from the management table 13 (Step 503).

When the host name (target host name) contained in the authentication information request is present in the host name acquired from the management table 13, that is, when the target host name is registered in the management table 13 (Step 504: Yes), the identification information verification section 47 determines whether the fingerprint authentication information corresponding to the target host name is present (registered) in the authentication information data 13b of the management table 13 (Step 505).

When the fingerprint authentication information corresponding to the target host name is registered in the authentication information data 13b of the management table 13 (Step 505: Yes), the identification information verification section 47 acquires all of the fingerprint authentication information registered in the authentication information data 13b of the management table 13, corresponding to the target host name (Step 506). The identification information verification section 47 notifies the authentication information transmission section 48 of the acquired fingerprint authentication information and the target host name.

The authentication information transmission section 48 generates an authentication information response that contains the notified fingerprint authentication information and transmits the generated authentication information response to the PC 1, which is a transmission source of the authentication information request (Step 507). After transmitting the authentication information response, the authentication information transmission section 48 removes the host name notified from the identification information verification section 47 and the fingerprint authentication information corresponding to the host name from the management table 13 (Step 508), thereby finishing the process. The host name and the fingerprint authentication information may be removed immediately after the authentication information response is transmitted, or may be removed after a predetermined period after the authentication information response is transmitted.

On the other hand, when the target host name is not registered in the management table 13 (Step 504: No), or when the fingerprint authentication information corresponding to the target host name is not registered in the authentication information data 13b of the management table 13 (Step 505: No), the identification information verification section 47 sends a notice that the fingerprint authentication information is not registered to the authentication information transmission section 48. Then, the authentication information transmission section 48 transmits an authentication information response that contains an error message stating that the fingerprint authentication information is not registered to the PC 1, which is a transmission source of the authentication information request (Step 509), thereby finishing the process.

In this way, the PC 1 as the user device generates identification information for identifying itself and notifies the printer 2 as the output device of the identification information. The printer 2 manages the identification information notified from the PC 1 and the authentication information read by the reading device 4 in a corresponding manner. Upon receiving a request from the user device, the printer 2 notifies the PC 1 of the authentication information managed to correspond to the identification information contained in the request so that the authentication information is registered in the PC 1. Therefore, the authentication information can be registered without needing to connect the reading device 4 such as a biometric sensor or an IC card reader to the PC 1 or to install dedicated software, thereby ensuring confidentiality and reducing the cost of the network output system.

As biometric authentication using biometrics, various authentication methods are available such as fingerprint authentication, vein authentication, or iris authentication. An authentication method used in user authentication can be selected depending on the security level or usage environment of confidential printing. Since the biometric sensor is configured to be attached to the reading device 4, even when the authentication method used in the confidential printing is changed, the PC 1 needs only to re-register the authentication information. Thus, it is possible to flexibly cope with the change of the system configuration.

Since the printer 2 acquires the authentication information corresponding to the identification information notified from the PC 1 and outputs the authentication information to the PC 1, the registration of the authentication information does not require inputting key strokes. Therefore, the printer 2 does not need to be equipped with a key-inputting device such as a numeric pad, thereby reducing the cost of the network output system.

In the first embodiment, the authentication information is transmitted as it is to the PC 1. However, the authentication information may be encrypted using a public key encryption method. In this case, the identification information generation section 31 of the PC 1 generates a public key and a private key at the time of generating the authentication information and registers the generated private key and the identification information in the storage device 5 in a corresponding manner. Moreover, the identification information generation section 31 notifies the identification information notice section 33 of the generated public key. The identification information notice section 33 generates and transmits an identification information notice that contains the identification information and the public key to the printer 2.

The identification information registration section 41 of the printer 2 registers the identification information and the public key contained in the received identification information notice in the storage device 6 in a corresponding manner. The authentication information transmission section 48 of the printer 2 encrypts the authentication information using the public key registered in the storage device 6 corresponding to the identification information at the time of generating an authentication information response and generates and transmits the authentication information response that contains the encrypted authentication information to the PC 1.

The authentication information registration section 35 of the PC 1 decrypts the encrypted authentication information contained in the authentication information response using the private key registered in the storage device 5 and registers the decrypted authentication information in the storage device 5. With this, it is possible to prevent leakage of the authentication information and to thus easily enhance security.

The communication between the PC 1 and the printer 2 on the network 3 may be performed with encryption. For example, as a method of exchanging keys in a confidential manner, a public key encryption method such as DH (Diffie Hellman) or SSL (Secure Socket Layer) may be used, or a shared key for key exchange between devices may be pre-registered. In this way, since an encryption key or a decryption key is automatically provided between the user device and the output device, the configuration becomes simple and the devices become easy to use. In addition, the exchange of keys is made in a confidential manner, the decryption key does not leak on a communication path, thereby ensuring confidentiality on the network 3 and enhancing security. In addition, it is possible to authenticate the user who performs output operations by performing the user authentication. In addition, it is possible to encrypt a communication path by using the DH or the SLL, thereby ensuring confidentiality on the network 3 and enhancing security.

In the first embodiment, the identification information generation section 31 generates the identification information. However, the identification information may be input from the outside. In this case, an identification information input unit which receives identification information input from the outside may be provided in the registration processing section 22 of the PC 1. When the identification information input unit receives the identification information input from the outside, the identification information generation section 31 may utilize the identification information received by the identification information input unit. With this, users can arbitrarily determine the identification information and thus can register the authentication information in the PC 1 using information that users can easily memorize.

In the first embodiment, it is described for the case in which the PC 1 and the printer 2 are connected via the network 3. However, the PC 1 may be connected to a print server serving as an output control device via the network 3, and the print server is equipped with the functions of the printer 2 according to the first embodiment, so that the authentication information registration process is performed by the print server and the PC 1. When printing, the print server outputs printing data that is authenticated by an authentication process to the printer connected to the print server so that the printing data is printed by the printer. With this, it is possible to enable confidential printing by connecting a printer that is not capable of performing confidential printing to the print server. Thus, it is possible to construct a system using conventionally available printers and to thus reduce the introduction cost of the network output system.

Since, in general, CPUs are mounted on the PC 1 and the printer 2, the PC 1 and the printer 2 are operated when programs are executed by the CPUs. The afore-mentioned functions which are carried out by the identification information generation section 31, the identification information notice section 33, the authentication information request section 34, the authentication information registration section 35, and a function of displaying various information on the identification information display section 32 of the PC 1 of the first embodiment, may be embodied by software and the software is executed by the CPU within the PC 1. Moreover, the afore-mentioned functions which are carried out by the identification information registration section 41, the identification information selection section 44, the authentication information acquisition section 45, the authentication information registration section 46, the identification information verification section 47, the authentication information transmission section 48, and a function of displaying various information on the identification information display section 43 of the printer 2 of the first embodiment, may be embodied by software and the software is executed by the CPU within the printer 2.

### Embodiment 2

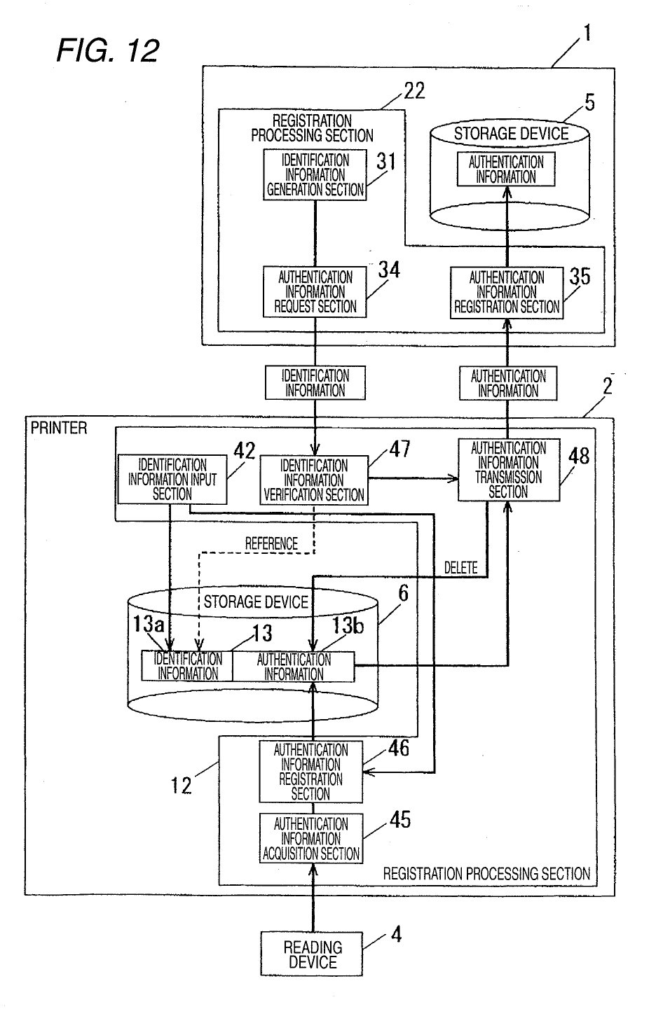

A second embodiment will be described with reference to FIG. 12. In the network output system of the first embodiment, the printer 2 is constructed to acquire and register the authentication information when the identification information is notified from the identification information notice from the PC 1. However, in the network output system of the second embodiment, the printer 2 is constructed to register the authentication information by directly inputting the identification information to the printer 2.

The network output system according to the second embodiment has a similar construction as the network output system according to the first embodiment shown in FIG. 1, except that the constructions of the registration processing section 12 of the printer 2 and the registration processing section 22 of the PC 1 are different from those of the first embodiment.

FIG. 12 is a block diagram showing the construction of the printer 2 and the PC 1 of the network output system according to the second embodiment, related to the identification information registration process and the authentication information registration process. In the registration processing section 12 of the printer 2 shown in FIG. 12, the identification information registration section 41, the identification information display section 43, and the identification information selection section 44 of the registration processing section 12 of the printer 2 of the first embodiment shown in FIG. 5 are removed. Instead, the registration processing section 12 of the printer 2 shown in FIG. 12 includes an identification information input section 42 that receives identification information input by users and registers the received identification information in the identification information data 13a of the management table 13 within the storage device 6.

In the registration processing section 22 of the PC 1 shown in FIG. 12, the identification information display section 32 and the identification information notice section 33 of the registration processing section 22 of the PC 1 of the first embodiment shown in FIG. 5 are removed. Components having the same functions as those of the registration processing section 12 of the printer 2 and the registration processing section 22 of the PC 1 shown in FIG. 5 will be denoted by the same reference numerals, and redundant descriptions thereof will be omitted.

Next, the operations of the network output system according to the second embodiment will be described. The difference between the network output system of the second embodiment and the network output system of the first embodiment lies in the identification information registration process and the first authentication information registration process. Therefore, only the operations of the identification information registration process and the first authentication information registration process will be described. Incidentally, detailed descriptions on the same operations as those of the first authentication information registration process of the printer 2 of the first embodiment described with reference to the flow chart of FIG. 9 will be omitted.

First, the operation of the identification information registration process will be described. In the network output system of the second embodiment, the identification information registration process is performed only by the PC 1. When the installation of the output port 27 into the PC 1 is executed by users, the identification information generation section 31 generates identification information for identifying the PC 1. When information that can identify the PC 1 in the network output system, such as an IP address, a host name, or an MAC address, which is used for identification of devices during communication using the network 3, account information used when users log into the network output system, or device unique information maintained in the PC 1 is used as the identification information, it is not necessary to notify users of the identification information if which of these information will be used is pre-determined. However, when information generated on a random basis is used as the identification information, it is necessary to be provided with the identification information display section 32 in a manner similar to the case of the first embodiment. The identification information generation section 31 displays the generated identification information on the identification information display section 32 so that users can recognize the identification information.

In the following descriptions, a host name configured in its own device for use in TCP/IP communication is used as the identification information. In this case, the identification information generation section 31 acquires a host name configured in its own device for use in TCP/IP communication and notifies the authentication information request section 34 of the acquired host name, thereby finishing the identification information registration process. In the second authentication information registration process which is performed after the identification information registration process is performed, the authentication information request section 34 generates an authentication information request using the host name notified from the identification information generation section 31.

Next, the operation of the first authentication information registration process will be described. Users input the identification information (in this case, a host name) generated by the identification information generation section 31 of the PC 1 in the identification information input section 42. When detecting an input of the host name, the identification information input section 42 registers the host name input thereto in the identification information data 13a of the management table 13 within the storage device 6. After registering the host name in the identification information data 13a of the management table 13, the identification information input section 42 notifies the authentication information registration section 46 of the host name.

The authentication information registration section 46 sends a notice that fingerprint authentication information is to be acquired to the authentication information acquisition section 45. Then, the authentication information acquisition section 45 acquires fingerprint authentication information from a fingerprint sensor as the reading device 4. The authentication information acquisition section 45 outputs the acquired fingerprint authentication information to the authentication information registration section 46. The authentication information registration section 46 registers the fingerprint authentication information input from the authentication information acquisition section 45 and the host name notified from the identification information input section 42 in the authentication information data 13b of the management table 13 within the storage device 6 in a corresponding manner, thereby finishing the first authentication information registration process.

In this way, in the second embodiment, the PC 1 as the user device generates identification information for identifying itself, and upon receiving the identification information from the outside, the printer 2 as the output device manages the identification information input thereto and the authentication information read by the reading device 4 in a corresponding manner. Upon receiving a request from the PC 1, the printer 2 notifies the PC 1 of the authentication information managed to correspond to the identification information contained in the request so that the authentication information is registered in the PC 1. Therefore, the authentication information can be registered without needing to connect the reading device 4 such as a biometric sensor or an IC card reader to the PC 1 or to install dedicated software, thereby ensuring confidentiality and reducing the cost of the network output system.

In a network output system such as a facsimile communication system in which the printer 2 is installed at a remote site, by allowing users to pre-register a pair of identification information and authentication information of the PC 1 in the printer 2, it is only necessary for the PC 1 to acquire the authentication information registered in the printer 2. Therefore, the processes of the PC 1 and the printer 2 can be performed in an asynchronous manner.

In the second embodiment, the authentication information is transmitted as it is to the PC 1. However, the authentication information may be encrypted using a public key encryption method. In this case, the identification information generation section 31 of the PC 1 generates a public key and a private key at the time of generating the identification information and registers the generated private key and the identification information in the storage device 5 in a corresponding manner. Moreover, the identification information generation section 31 notifies the authentication information request section 34 of the generated public key. The authentication information request section 34 generates and transmits an identification information notice that contains the identification information and the public key to the printer 2.

The identification information verification section 47 of the printer 2 registers the identification information and the public key contained in the received authentication information request in the storage device 6 in a corresponding manner. The authentication information transmission section 48 of the printer 2 encrypts the authentication information using the public key registered in the storage device 6 corresponding to the identification information at the time of generating an authentication information response and generates and transmits the authentication information response that contains the encrypted authentication information to the PC 1.

The authentication information registration section 35 of the PC 1 decrypts the encrypted authentication information contained in the authentication information response using the private key registered in the storage device 5 and registers the decrypted authentication information in the storage device 5. With this, it is possible to prevent leakage of the authentication information and to thus easily enhance security.

The communication between the PC 1 and the printer 2 on the network 3 may be performed with encryption. For example, as a method of exchanging keys in a confidential manner, a public key encryption method such as DH (Diffie Hellman) or SSL (Secure Socket Layer) may be used, or a shared key for key exchange between devices may be pre-registered. In this way, since an encryption key or a decryption key is automatically provided between the user device and the output device, the configuration becomes simple and the devices become easy to use. In addition, the exchange of keys is made in a confidential manner, the decryption key does not leak on a communication path, thereby ensuring confidentiality on the network 3 and enhancing security. In addition, it is possible to authenticate the user who performs output operations by performing the user authentication. In addition, it is possible to encrypt a communication path by using the DH or the SLL, thereby ensuring confidentiality on the network 3 and enhancing security.

In the second embodiment, the identification information generation section 31 generates the identification information. However, the identification information may be input from the outside. In this case, an identification information input unit which receives identification information input from the outside may be provided in the registration processing section 22 of the PC 1. When the identification information input unit receives the identification information input from the outside, the identification information generation section 31 may utilize the identification information received by the identification information input unit. With this, users can arbitrarily determine the identification information and thus can register the authentication information in the PC 1 using information that users can easily memorize.

In the second embodiment, it is described for the case in which the PC 1 and the printer 2 are connected via the network 3. However, the PC 1 may be connected to a print server serving as an output control device via the network 3, and the print server is equipped with the functions of the printer 2 according to the second embodiment, so that the authentication information registration process is performed by the print server and the PC 1. When printing, the print server outputs printing data that is authenticated by an authentication process to the printer connected to the print server so that the printing data is printed by the printer. With this, it is possible to enable confidential printing by connecting a printer that is not capable of performing confidential printing to the print server. Thus, it is possible to construct a system using conventionally available printers and to thus reduce the introduction cost of the network output system.

Since, in general, CPUs are mounted on the PC 1 and the printer 2, the PC 1 and the printer 2 are operated when programs are executed by the CPUs. The afore-mentioned functions which are carried out by the identification information generation section 31, the authentication information request section 34, and the authentication information registration section 35 of the PC 1 of the second embodiment, may be embodied by software and the software is executed by the CPU within the PC 1. Moreover, the afore-mentioned functions which are carried out by the identification information display section 42, the authentication information acquisition section 45, the authentication information registration section 46, the identification information verification section 47, and the authentication information transmission section 48 of the printer 2 of the second embodiment, may be embodied by software and the software is executed by the CPU within the printer 2.

### Embodiment 3

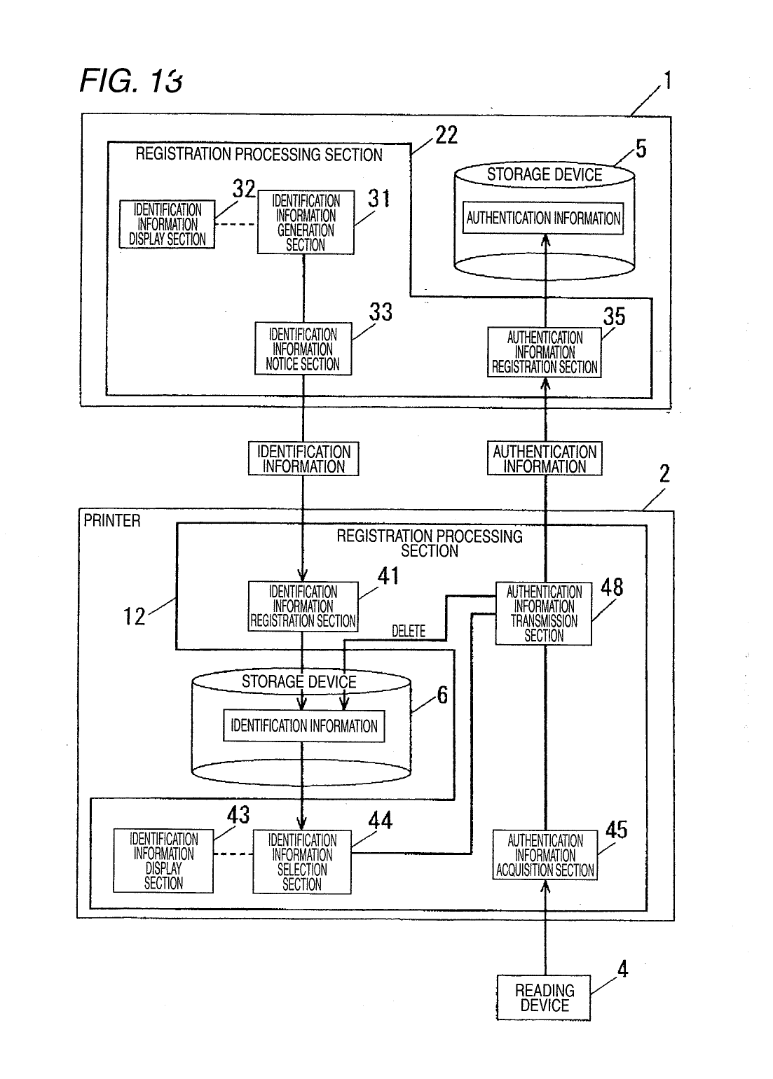

A third embodiment will be described with reference to FIG. 13. In the network output system of the first embodiment, the PC 1 is constructed to acquire the authentication information from the printer 2 by performing the authentication information registration process after performing the identification information registration process. However, in the network output system of the third embodiment, the PC 1 acquires the authentication information from the printer 2 without performing the identification information registration process.

The network output system according to the third embodiment has a similar construction as the network output system according to the first embodiment shown in FIG. 1, except that the constructions of the registration processing section 12 of the printer 2 and the registration processing section 22 of the PC 1 are different from those of the first embodiment.

FIG. 13 is a block diagram showing the constructions of the printer 2 and the PC 1 of the network output system according to the third embodiment, related to the identification information registration process and the authentication information registration process. In the registration processing section 22 of the PC 1 shown in FIG. 13, the authentication information request section 34 of the registration processing section 22 of the PC 1 of the first embodiment shown in FIG. 5 is removed. In the registration processing section 12 of the printer 2 shown in FIG. 13, the authentication information registration section 46 and the identification information verification section 47 of the registration processing section 12 of the printer 2 of the first embodiment shown in FIG. 5 are removed. Components having the same functions as those of the registration processing section 12 of the printer 2 and the registration processing section 22 of the PC 1 shown in FIG. 5 will be denoted by the same reference numerals, and redundant descriptions thereof will be omitted.

Next, the operations of the network output system according to the third embodiment will be described. The network output system of the third embodiment and the network output system of the first embodiment are different in that in the network output system of the first embodiment, the PC 1 acquires the authentication information from the printer 2 by performing the identification information registration process and thereafter the authentication information registration process, while in the network output system of the third embodiment, the PC 1 acquires the authentication information when performing the identification information registration process. That is, the difference between the network output system of the third embodiment and the network output system of the first embodiment lies in the operation of the identification information registration process. Therefore, only the operations of the identification information registration process will be described. Incidentally, detailed descriptions on the same operations as those of the first embodiment will be omitted.

First, the operations of the identification information registration process of the PC 1 will be described. When the installation of the output port 27 into the PC 1 is executed by users, the identification information generation section 31 acquires a host name (identification information) configured in its own device for use in TCP/IP communication. The identification information generation section 31 displays the acquired host name on the identification information display section 32 and notifies the identification information notice section 33 of the acquired host name.

The identification information notice section 33 generates and transmits an identification information notice that contains the host name notified from the identification information generation section 31 to the printer 2 and requests authentication information to the printer 2. After the identification information notice section 33 transmits the identification information notice, the PC 1 enters an authentication information response waiting state to receive a response from the printer 2.

Upon receiving the authentication information response from the printer 2, the authentication information registration section 35 determines whether fingerprint authentication information (authentication information) is successfully acquired. When the fingerprint authentication information is successfully acquired, that is, when the fingerprint authentication information is contained in the authentication information response, the authentication information registration section 35 extracts the fingerprint authentication information contained in the authentication information response and registers the extracted fingerprint authentication information in the authentication information storage section 23 within the storage device 5, thereby finishing the process.

On the other hand, when the fingerprint authentication information was not successfully acquired, that is, when an error message is contained in the authentication information response, the authentication information registration section 35 displays an error message stating that the acquisition of the fingerprint authentication information was not successful on the identification information display section 32, thereby finishing the process.

Next, the operations of the identification information registration process of the printer 2 will be described. Upon receiving the identification information notice that contains the host name from the PC 1, the identification information registration section 41 extracts the host name contained in the identification information notice and registers the extracted host name in the storage device 6. After the identification information is registered in the storage device 6, the identification information selection section 44 acquires the host names registered in the storage device 6 and displays the acquired host names on the identification information display section 43.

When users select a host name of their PC 1 from the host names displayed on the identification information display section 43 using the operation panel section 15, the operation panel section 15 notifies the identification information selection section 44 of the host name selected by the users. The identification information selection section 44 notifies the authentication information transmission section 48 of the host name notified from the operation panel section 15.

The authentication information transmission section 48 sends a notice that fingerprint authentication information is to be acquired to the authentication information acquisition section 45. Then, the authentication information acquisition section 45 acquires fingerprint authentication information from a fingerprint sensor as the reading device 4. The authentication information acquisition section 45 outputs the acquired fingerprint authentication information to the authentication information transmission section 48. The authentication information transmission section 48 generates an authentication information response that contains the fingerprint authentication information input from the authentication information acquisition section 45 and transmits the generated authentication information response to the PC 1 to which the host name notified from the identification information selection section 44 is assigned.

After transmitting the authentication information response, the authentication information transmission section 48 deletes the host name, notified from the identification information selection section 44, from the management table 13, thereby finishing the process.

In this way, in the third embodiment, the PC 1 as the user device generates identification information for identifying itself and notifies the printer 2 of the identification information. The printer 2 as the output device manages the identification information notified from the PC 1 to display all of the identification information. When one of the displayed identification information is selected, the authentication information read by the reading device 4 is notified to the PC 1 designated by the selected identification information so that the authentication information is registered in the PC 1. Therefore, the authentication information can be registered without needing to connect the reading device 4 such as a biometric sensor or an IC card reader to the PC 1 or to install dedicated software, thereby ensuring confidentiality and reducing the cost of the network output system.

In the third embodiment, the authentication information is transmitted as it is to the PC 1. However, the authentication information may be encrypted using a public key encryption method. In this case, the identification information generation section 31 of the PC 1 generates a public key and a private key at the time of generating the authentication information and registers the generated private key and the identification information in the storage device 5 in a corresponding manner. Moreover, the identification information generation section 31 notifies the identification information notice section 33 of the generated public key. The identification information notice section 33 generates and transmits an identification information notice that contains the identification information and the public key to the printer 2.

The identification information registration section 41 of the printer 2 registers the identification information and the public key contained in the received identification information notice in the storage device 6 in a corresponding manner. The authentication information transmission section 48 of the printer 2 encrypts the authentication information using the public key registered in the storage device 6 corresponding to the identification information at the time of generating an authentication information response and generates and transmits the authentication information response that contains the encrypted authentication information to the PC 1.

The authentication information registration section 35 of the PC 1 decrypts the encrypted authentication information contained in the authentication information response using the private key registered in the storage device 5 and registers the decrypted authentication information in the storage device 5. With this, it is possible to prevent leakage of the authentication information and to thus easily enhance security.

The communication between the PC 1 and the printer 2 on the network 3 may be performed with encryption. For example, as a method of exchanging keys in a confidential manner, a public key encryption method such as DH (Diffie Hellman) or SSL (Secure Socket Layer) may be used, or a shared key for key exchange between devices may be pre-registered. In this way, since an encryption key and a decryption key is automatically provided between the user device and the output device, the configuration becomes simple and the devices become easy to use. In addition, the exchange of keys is made in a confidential manner, the decryption key does not leak on a communication path, thereby ensuring confidentiality on the network 3 and enhancing security. In addition, it is possible to authenticate the user who performs output operations by performing the user authentication. In addition, it is possible to encrypt a communication path by using the DH or the SLL, thereby ensuring confidentiality on the network 3 and enhancing security.

In the third embodiment, the identification information generation section 31 generates the identification information. However, the identification information may be input from the outside. In this case, an identification information input unit which receives identification information input from the outside may be provided in the registration processing section 22 of the PC 1. When the identification information input unit receives the identification information input from the outside, the identification information generation section 31 may utilize the identification information received by the identification information input unit. With this, users can arbitrarily determine the identification information and thus can register the authentication information in the PC 1 using information that users can easily memorize.

In the third embodiment, it is described for the case in which the PC 1 and the printer 2 are connected via the network 3. However, the PC 1 may be connected to a print server serving as an output control device via the network 3, and the print server is equipped with the functions of the printer 2 according to the third embodiment, so that the authentication information registration process is performed by the print server and the PC 1. When printing, the print server outputs printing data that is authenticated by an authentication process to the printer connected to the print server so that the printing data is printed by the printer. With this, it is possible to enable confidential printing by connecting a printer that is not capable of performing confidential printing to the print server. Thus, it is possible to construct a system using conventionally available printers and to thus reduce the introduction cost of the network output system.

Since, in general, CPUs are mounted on the PC 1 and the printer 2, the PC 1 and the printer 2 are operated when programs are executed by the CPUs. The afore-mentioned functions which are carried out by the identification information generation section 31, the identification information notice section 33, the authentication information registration section 35, and a function of displaying various information on the identification information display section 32 of the PC 1 of the third embodiment, may be embodied by software and the software is executed by the CPU within the PC 1. Moreover, the afore-mentioned functions which are carried out by the identification information registration section 41, the identification information selection section 44, the authentication information acquisition section 45, the authentication information transmission section 48, and a function of displaying various information on the identification information display section 43 of the printer 2 of the third embodiment, may be embodied by software and the software is executed by the CPU within the printer 2.

### Embodiment 4

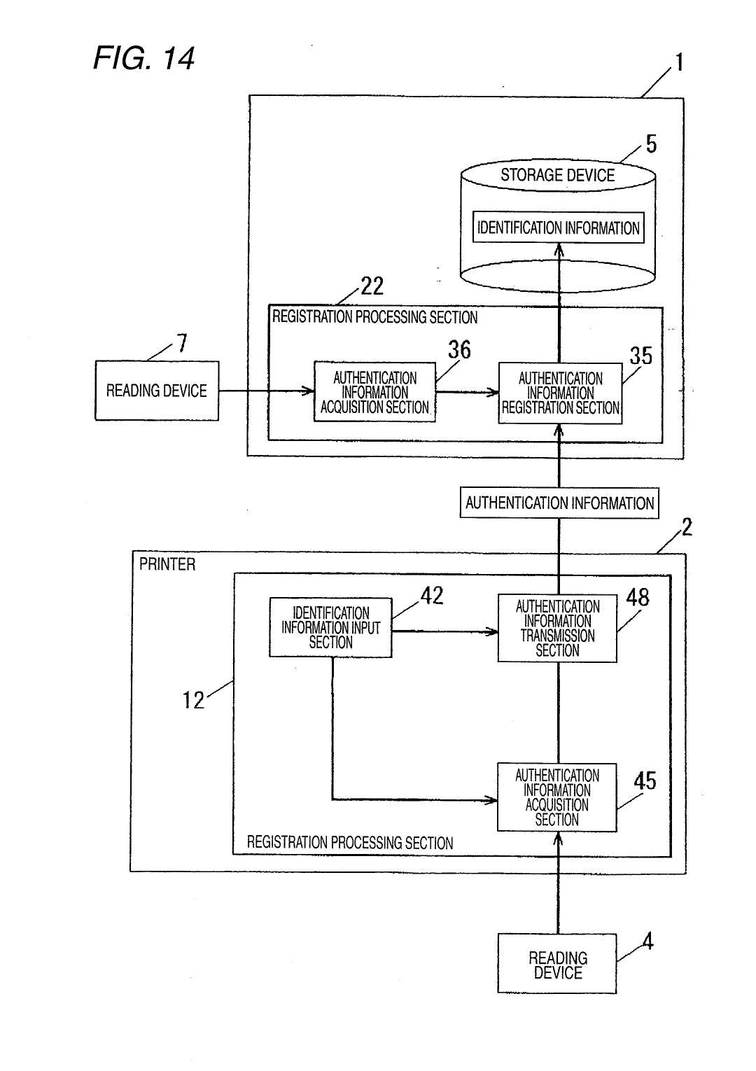

A fourth embodiment will be described with reference to FIGS. 14 to 16. In the network output system according to the first to third embodiments, the reading device 4 is connected to the printer 2. For this reason, there is a problem that users must move to the place at which the printer 2 is installed in order to register the authentication information. To solve such a problem, the network output system according to the fourth embodiment allows registering the authentication information using only the PC 1.

The network output system according to the fourth embodiment has a similar construction as the network output system according to the first embodiment, except that the reading device is connected to the PC 1 and that the constructions of the registration processing section 12 of the printer 2 and the registration processing section 22 of the PC 1 are different from those of the first embodiment.

FIG. 14 is a block diagram showing the constructions of the printer 2 and the PC 1 of the network output system according to the fourth embodiment, related to the authentication information registration process. In the registration processing section 12 of the printer 2 shown in FIG. 14, the authentication information registration section 46 and the identification information verification section 47 of the registration processing section 12 of the printer 2 of the second embodiment shown in FIG. 12 are removed. In addition, in the registration processing section 22 of the PC 1 shown in FIG. 14, the identification information generation section 31 of the registration processing section 22 of the PC 1 of the second embodiment shown in FIG. 12 is removed. Instead of the authentication information request section 34, the registration processing section 22 of the PC 1 shown in FIG. 14 includes an authentication information acquisition section 36 that acquires authentication information from a reading device 7 having the same function as that of the reading device 4 that is connected to the printer 2. Components having the same functions as those of the registration processing section 12 of the printer 2 and the registration processing section 22 of the PC 1 of the second embodiment shown in FIG. 12 will be denoted by the same reference numerals, and redundant descriptions thereof will be omitted.

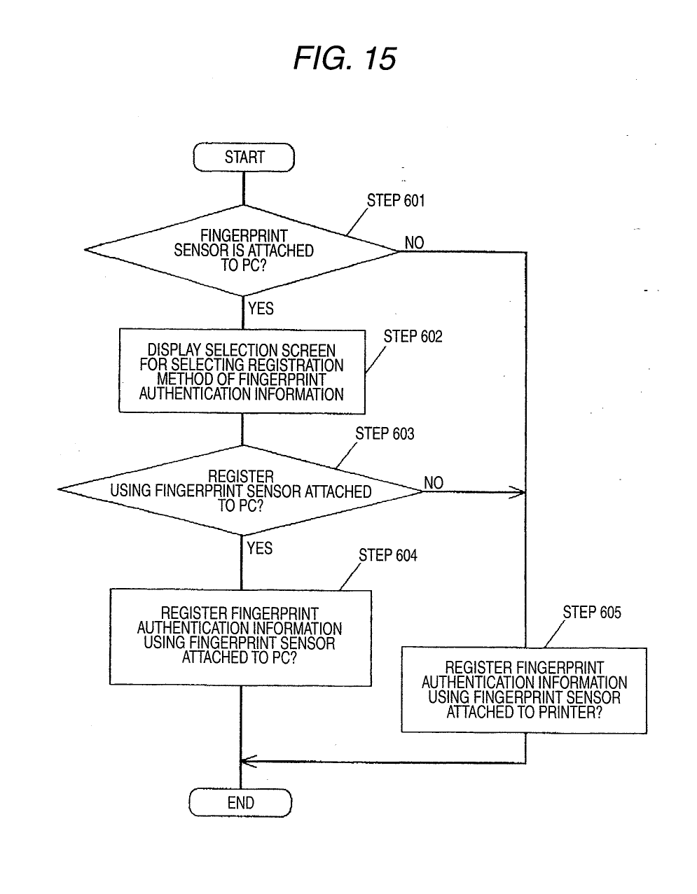

Next, the operations of the authentication information registration process of the network output system according to the fourth embodiment will be described with reference to the flow chart of FIG. 15. First, when the installation of the output port 27 into the PC 1 is executed by users, the authentication information acquisition section 36 determines whether the reading device 7 (fingerprint sensor) is attached to its own device (PC 1) (Step 601).

When it is possible to detect that the reading device 7 is attached, the authentication information acquisition section 36 displays a registration method selection screen on a display section (not shown) of the PC 1 to allow users to select whether they will use the reading device 7 attached to the PC 1 or the reading device 4 attached to the printer 2 (Step 602).

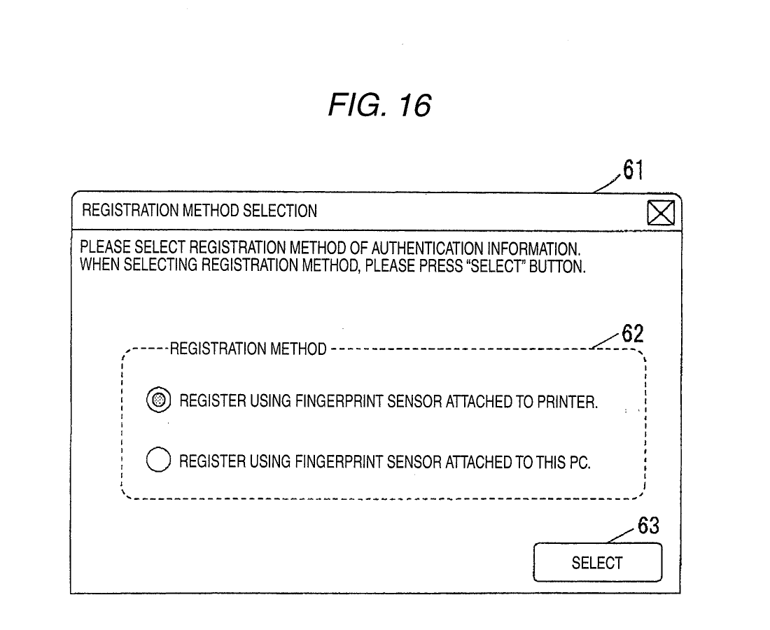

FIG. 16 is a diagram showing an example of the registration method selection screen. In FIG. 16, the registration method selection screen 61 includes a registration method selection box 62 that allows users to select whether they will use the reading device 7 attached to the PC 1 or the reading device 4 attached to the printer 2 and a Select button 63 for confirming the selection. Users start registering the authentication information (fingerprint authentication information) by inputting operations to the registration method selection box 62 and the Selection button 63 on the registration method selection screen 61.

When “Register using fingerprint sensor attached to this PC” is selected on the registration method selection box 62 of the registration method selection screen 61 and when the pressing of the Selection button 63 is detected (Step 603: Yes), the fingerprint authentication information is registered using the fingerprint sensor, which is the reading device 7 attached to the PC 1 (Step 604).

Specifically, when “Register using fingerprint sensor attached to this PC” is selected on the registration method selection box 62 of the registration method selection screen 61 and when the pressing of the Selection button 63 is detected, the authentication information acquisition section 36 acquires the fingerprint authentication information from the fingerprint sensor as the reading device 7 and outputs the acquired fingerprint authentication information to the authentication information registration section 35. The authentication information registration section 35 registers the fingerprint authentication information input from the authentication information acquisition section 36 in the storage device 5 (Step 604), thereby finishing the process.

On the other hand, when it is not possible to detect that the reading device 7 is attached (that is, when the reading device 7 is not attached to the PC 1) (Step 601: No), or when “Register using the fingerprint sensor attached to the printer” is selected on the registration method selection box 62 of the registration method selection screen 61 and the pressing of the Selection button 63 is detected (Step 603: No), the fingerprint authentication information is registered using the fingerprint sensor, which is the reading device 4 attached to the printer 2 (Step 605).

Specifically, when it is not possible to detect that the reading device 7 is attached (that is, when the reading device 7 is not attached to the PC 1) (Step 601: No), or when “Register using the fingerprint sensor attached to the printer” is selected on the registration method selection box 62 of the registration method selection screen 61 and the pressing of the Selection button 63 is detected, the authentication information registration section 35 enters an authentication information response waiting state to receive a response from the printer 2.

Users input the identification information (in this case, a host name) for identifying the PC 1 in the identification information input section 42. When detecting an input of the host name, the identification information input section 42 notifies the authentication information transmission section 48 of the input host name and sends a notice that the fingerprint authentication information is to be acquired to the authentication information acquisition section 45. Then, the authentication information acquisition section 45 acquires the fingerprint authentication information from the fingerprint sensor as the reading device 4. The authentication information acquisition section 45 outputs the acquired fingerprint authentication information to the authentication information transmission section 48. The authentication information registration section 46 generates an authentication information response that contains the fingerprint authentication information input from the authentication information acquisition section 45 and transmits the generated authentication information response to the PC 1 designated by the host name notified from the identification information input section 42.

Upon receiving the authentication information response from the printer 2, the authentication information registration section 35 of the PC 1 extracts the fingerprint authentication information from the received authentication information response and registers the extracted fingerprint authentication information in the storage device 5, thereby finishing the process.

In this way, in the fourth embodiment, whether the reading device 7 connected to the PC 1 which is the user device or the reading device 4 connected to the printer 2 which is the output device is to be used is selected by the instructions from the outside. Therefore, when the PC 1 attached to the reading device 7 or the PC 1 having the functions of the reading device 7 incorporated therein is used to log into the network output system, it is possible to register the authentication information using the reading device 7 attached to the PC 1. Accordingly, it is possible to facilitate the registration of the authentication information in the PC 1.

The communication between the PC 1 and the printer 2 on the network 3 may be performed with encryption. For example, as a method of exchanging keys in a confidential manner, a public key encryption method such as DH (Diffie Hellman) or SSL (Secure Socket Layer) may be used, or a shared key for key exchange between devices may be pre-registered. In this way, since an encryption key and a decryption key are automatically provided between the user device and the output device, the configuration becomes simple and the devices become easy to use. In addition, the exchange of keys is made in a confidential manner, the decryption key does not leak on a communication path, thereby ensuring confidentiality on the network 3 and enhancing security. In addition, it is possible to authenticate the user who performs output operations by performing the user authentication. In addition, it is possible to encrypt a communication path by using the DH or the SLL, thereby ensuring confidentiality on the network 3 and enhancing security.

In the fourth embodiment, it is described for the case in which the PC 1 and the printer 2 are connected via the network 3. However, the PC 1 may be connected to a print server serving as an output control device via the network 3, and the print server is equipped with the functions of the printer 2 according to the third embodiment, so that the authentication information registration process is performed by the print server and the PC 1. When printing, the print server outputs printing data that is authenticated by an authentication process to the printer connected to the print server so that the printing data is printed by the printer. With this, it is possible to perform confidential printing by connecting a printer that is not capable of performing confidential printing to the print server. Thus, it is possible to construct a system using conventionally available printers and to thus reduce the introduction cost of the network output system.

Since, in general, CPUs are mounted on the PC 1 and the printer 2, the PC 1 and the printer 2 are operated when programs are executed by the CPUs. The afore-mentioned functions which are carried out by the authentication information acquisition section 36 and the authentication information registration section 35 of the PC 1 of the fourth embodiment, may be embodied by software and the software is executed by the CPU within the PC 1. Moreover, the afore-mentioned functions which are carried out by the identification information input section 42, the authentication information acquisition section 45, and the authentication information transmission section 48 of the printer 2 of the fourth embodiment, may be embodied by software and the software is executed by the CPU within the printer 2.

### INDUSTRIAL APPLICABILITY

As described above, the network output system according to the embodiments is useful for registration of authentication information in a system in which a user device that transmits output data that contains authentication information and data to be output is connected via a network to an output device, connected to a reading device, that outputs the data contained in the output data when the authentication information contained in the output data from the user device is identical to the authentication information read by the reading device. The network output system according to the embodiments is particularly suitable for a system in which a large number of user devices are connected to a network.

This application is based upon and claims the benefit of priority of Japanese Patent Application No 2007-12309 filed on Jan. 23, 2007, the contents of which is incorporated herein by references in its entirety.

What is claimed is:

1. A network output system, comprising:
a user device that transmits output data containing authentication information; and
an output device that has a reading unit and receives the output data from the user device and that outputs data contained in the output data when the authentication information contained in the output data is identical to the authentication information read from the reading unit,
wherein the user device includes:
a memory that stores the authentication information received from the output device; and
a processor that controls to transmit identification information for identifying its own device on a network, to the output device, and to store the authentication information received from the output device in the memory; and
wherein the output device includes a processor that controls to receive the identification information from the user device, to receive authentication information from the reading unit, and to transmit the authentication information read from the reading unit to the user device identified by the identification information.

2. The network output system according to claim 1, wherein the processor of the user device controls to transmit a notice of request for authentication information to the output device after transmitting the identification information, the notice of request containing identification information;
wherein the output device includes a memory that stores the identification information transmitted from the user device and the authentication information received from the reading unit in a corresponding manner; and
wherein the processor of the output device controls to read authentication information corresponding to the identification information contained in the notice of request from the memory and to transmit the read authentication information to the user device identified by the identification information when receiving the notice of request from the user device.

3. The network output system according to claim 2, wherein the processor of the output device controls to delete the identification information for identifying the corresponding user device from the memory after transmitting the authentication information to the user device.

4. The network output system according to claim 2, wherein the processor of the output device controls to delete the authentication information corresponding to the identification information of the corresponding user device from the memory after transmitting the authentication information to the user device.

5. The network output system according to claim 2, wherein the processor of the output device controls to delete the identification information from the memory after a predetermined period elapses since the identification information of the user device is stored in the memory.

6. The network output system according to claim 2, wherein the processor of the output device controls to acquire the authentication information read by the reading unit if the identification information of the user device is registered in the memory.

7. The network output system according to claim 1, wherein the identification information of the user device contains at least one of an IP address, a MAC address, a host name, and account information used for logging into a network.

8. The network output system according to claim 1, wherein the user device includes an input unit for inputting the identification information; and
wherein the processor of the user device controls to transmit the identification information input from the input unit to the output device.

9. The network output system according to claim 1, wherein the processor of the user device controls to generate a public key and a private key, to transmit the identification information along with the public key to the output device, and to decrypt the authentication information received from the output device using the private key to store the decrypted authentication information in the memory; and
wherein the processor of the output device controls to encrypt the authentication information to be transmitted to the user device using the public key.

10. The network output system according to claim 1, wherein the processor of the user device controls to encrypt data to be transmitted to the output device; and
wherein the processor of the output device controls to encrypt data to be transmitted to the user device.

11. The network output system according to claim 1, wherein the processor of the output device controls to receive a plurality of authentication information from the reading unit and to transmit the plurality of authentication information to the user device.

12. The network output system according to claim 1, wherein the output device includes:
a memory that stores the identification information received from the user device;
an input unit for inputting instructions from outside; and
a display unit that displays the identification information stored in the memory, and
wherein when identification information is designated by the input unit from the identification information displayed on the display unit and the authentication information from the reading unit is received, the processor controls to transmit the read authentication information to the user device identified by the identification information.

13. A network output system, comprising:
a user device that transmits output data containing authentication information; and
an output device that has a reading unit and receives the output data from the user device and that outputs data contained in the output data when the authentication information contained in the output data is identical to the authentication information read from the reading unit,
wherein the user device includes:
a memory that stores the authentication information received from the output device; and
a processor that controls to store the authentication information received from the output device in the memory; and
wherein the output device includes:
an input unit for inputting instructions from outside; and
a processor that controls, when identification information for identifying a device on a network is input from the input unit, to transmit the authentication information received from the reading unit to the user device identified by the identification information.

14. The network output system according to claim 13, wherein the processor of the user device controls to transmit a notice of request for authentication information to the output device, the notice of request containing the identification information for identifying its own device on a network,
wherein the output device includes a memory that stores the identification information for identifying a device on a network, input from the input unit, and the authentication information received from the reading unit in a corresponding manner; and
wherein the processor of the output device controls to read authentication information corresponding to the identification information contained in the notice of request from the memory and to transmit the read authentication information to the user device identified by the identification information when receiving the notice of request for the authentication information from the user device.

15. A registration method of authentication information used in a system including a user device that transmits output data containing authentication information, and an output device that has a reading unit and receives the output data from the user device and that outputs data contained in the output data when the authentication information contained in the output data is identical to the authentication information read from the reading unit, the method comprising:
transmitting identification information for identifying its own device on a network from the user device to the output device;
receiving the identification information by the output device from the user device and receiving the authentication information by the output device from the reading unit;
transmitting the received authentication information from the output device to the user device identified by the identification information; and
storing the authentication information received from the output device in a memory of the user device.
